(19) United States
(12) Patent Application Publication
(10) Pub. No.: US 2014/0136712 A1
(43) Pub. Date: May 15, 2014

(54) CLOUD RESOURCES AS A SERVICE MULTI-TENANT DATA MODEL

(71) Applicant: LG CNS CO., LTD., (US)

(72) Inventors: Hyun Jun Kim, Seoul (KR); Sang Mi Choi, Seoul (KR); Hwan Joon Choi, Gyeonggi-do (KR); Eun Hwa Lee, Gyeonggi-do (KR); Kyung In Kang, Seoul (KR); Sang Ok Song, Gyeonggi-do (KR); Hang Seub Lim, Gyeonggi-do (KR)

(73) Assignee: LG CNS CO., LTD., Seoul (KR)

(21) Appl. No.: 13/860,996

(22) Filed: Apr. 11, 2013

(30) Foreign Application Priority Data
Apr. 12, 2012 (KR) 10-2012-0038162

(51) Int. Cl. H04L 12/911

(52) U.S. Cl. CPC H04L 47/70
USPC 709/226

(57) ABSTRACT

Embodiments of the present invention relate to cloud resources as a service in a multi-tenant data model. Specifically, a system (e.g., server) is configured to connect with any number of tenant devices in a multi-tenant environment. The system provides a set of cloud resources to each tenant including Software as a Service (SaaS) application development and customization.

### TECHNICAL FIELD

In general, the present invention relates to the field of data processing. Specifically, the present invention relates to cloud resources as a service multi-tenant data model in a cloud computing environment including application development and storage.

### BACKGROUND

The networked computing environment (e.g., cloud computing environment) is an enhancement to the predecessor grid environment, whereby multiple grids and other computation resources may be further enhanced by one or more additional abstraction layers (e.g., a cloud layer), thus making disparate devices appear to an end-user (e.g., tenant in a multi-tenant environment) as a single pool of seamless resources. These resources may include such things as physical or logical computing engines, servers and devices, device memory, and storage devices, among others.

The advent of cloud-based computing architectures has opened new possibilities for the rapid and scalable deployment of on-line sites and services. A cloud-based architecture may deploy a set of hosted resources such as processors, operating systems, software, and other components that can be combined or strung together to form virtual machines. A cloud computing customer can request the instantiation of a virtual machine or set of machines from those resources from a central server or management system to perform intended tasks or applications. For example, a user may wish to set up and instantiate a virtual server from the cloud to create a storefront to market products or services on a temporary basis (i.e., to sell tickets to an upcoming sports or musical performance. The user can lease or subscribe to the set of resources needed to build and run the set of instantiated virtual machines on a comparatively short-term basis, such as hours or days, for their intended application.

For example, a user may wish to utilize or develop software in the cloud. Software utilized in this manner typically referred to as Software as a Service (SaaS). SaaS is a mode for providing application software through the Internet, in which software providers deploy applications on a server uniformly, and users may subscribe desired applications from software providers through the Internet according to their practical demands and obtain applications as provided by software providers through the Internet. Unlike a traditional (on-premise) mode in which software applications are purchased and installed on the users' computers, in SaaS mode, users utilize functions of desired application software by using web-based applications as subscribed from software providers. For example, users may utilize the web-based application for customer relationship management, online sales, commodity inventory management, order tracking, and so on.

An advantage of SaaS is that users do not need to maintain the software, but software providers are responsible for all work related to management and maintenance of the application. In this case, users who rent/utilize SaaS services do not need to purchase, construct, or maintain infrastructure related to traditional applications, and they do not need to have expertise in application software maintenance. They only need to have the ability to utilize the application software.

Compared with on-premise software technology, SaaS boasts a significant difference that the application employs a multi-tenant mode during operation. Multi-tenancy is a model of software architecture. Under this model, only a single instance of the application runs on servers of SaaS providers (i.e., multiple tenants of the application need to share this single instance). Multi-tenancy is relative to single-tenancy. In a single-tenant architecture, one instance of the application only serves one tenant.

Traditional software systems are typically created for a dedicated purpose with limited optional behaviors and features. Major feature and behavior changes to traditional software systems require significant development efforts and the creation of new versions. Systems that are created to be flexible require extensive custom development work to meet custom requirements.

There is a need to provide a system and a method for providing database services that does not have the configurability constraints of traditional database services. User information technology (IT) environments and the technical requirements widely differ among different organizations. In typical environments, the selection and implementation of database services may impose unnecessary restrictions of alternative implementations and may require additional conversion work. Heretofore, several unsuccessful attempts have been made to address these shortcomings.

U.S. Patent Application 20110179110 discloses a presentation manager configured to provide an interface requesting information regarding a proposal from a digital device over a network and receive the information on the digital device.

U.S. Patent Application 20110126168 discloses a cloud platform for managing Software as a Service (SaaS) resources which allows customers to consume developed SaaS applications with associated customer data.

U.S. Patent Application 20110010394 discloses client-specific data customization for shared databases in which a client-specific data field identifier for each item of a client-specific data is associated with a first client in a set of clients received at a processor associated with a Software as a Service (SaaS) module.

U.S. Patent Application 20110191702 discloses a system and method for polymorphic content generation in a multi-application, multi-tenant environment.

U.S. Patent Application 20100332629 discloses a secure custom application which facilitates virtually seamless migration of custom applications to and from a cloud computing environment in response to user needs.

U.S. Patent Application 20090037828 discloses mechanisms and methods for editing an on-demand database service graphical user interface that can enable embodiments to edit desired portions of the interface in a more flexible manner. The ability of embodiments to provide such additional flexibility may lead to more efficient and effective interface editing.

None of these references, however, teach a method for providing a set of cloud resources as a service that does not have the configurability constraints of traditional on-premises resources.

### SUMMARY

Embodiments of the present invention relate to the provision of cloud resources as a service (e.g., SaaS, IaaS, PaaS, etc.) in a multi-tenant data model. Specifically, a system (e.g., server) is configured to connect with any number of tenant devices in a multi-tenant environment. The system provides a set of cloud resources to each tenant including SaaS application development and customization.

A first aspect of the present invention provides a system for providing a set of cloud resources in a cloud computing environment, comprising: a memory medium comprising instructions; a bus coupled to the memory medium; and a processor coupled to the bus that when executing the instructions causes the system to: connect to a tenant device among multiple tenant devices via a communication link; retrieve business data associated with a tenant from a storage area, wherein the tenant is associated with the tenant device; define application data, wherein the application data is associated with the business data; generate an interface template based on the application data; render a graphical user interface on the tenant device based on the interface template; edit the graphical user interface using the tenant device to create a desired graphical user interface; and generate an application based on the desired graphical user interface.

A second aspect of the present invention provides a computer-implemented method for providing cloud resources as a service in a cloud computing environment, comprising: connecting a server to a tenant device among multiple tenant devices via a communication link; retrieving business data associated with a tenant from a storage area, wherein the tenant is associated with the tenant device; defining application data, wherein the application data is associated with the business data; generating an interface template based on the application data; rendering a graphical user interface on the tenant device based on the interface template; editing the graphical user interface using the tenant device to create a desired graphical user interface; and generating an application based on the desired graphical user interface.

A third aspect of the present invention provides a computer program product for managing Software as a Service (SaaS) resources in a networked computing environment, the computer program product comprising a computer readable storage media, and program instructions stored on the computer readable storage media, to: connect to a tenant device among multiple tenant devices via a communication link; retrieve business data associated with a tenant from a storage area, wherein the tenant is associated with the tenant device; define application data, wherein the application data is associated with the business data; generate an interface template based on the application data; render a graphical user interface on the tenant device based on the interface template; edit the graphical user interface using the tenant device to create a desired graphical user interface; and generate an SaaS application based on the desired graphical user interface.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 depicts a system diagram according to an embodiment of the present invention.

FIG. 5 depicts a Software as a Service (SaaS) application development platform according to an embodiment of the present invention.

FIG. 6 depicts a pattern-based graphical user interface schematic according to an embodiment of the present invention.

FIG. 7A depicts a data view screen shot according to an embodiment of the present invention.

FIG. 7B depicts a logical diagram of a data view according to an embodiment of the present invention.

FIG. 8 depicts a graphical user interface method flow diagram according to an embodiment of the present invention.

FIG. 9 depicts a schematic diagram of a query process according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which embodiments are shown. This disclosure may, however, be embodied in many different forms and should not be construed as limited to the embodiments set forth herein. Rather, these embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As used herein, the term “communication link” is intended to include any means of connecting one location to another for the purpose of transmitting and receiving information. The term “metadata” refers to any set of data that describes and gives information about other data.

It is understood in advance that although this disclosure includes a detailed description of cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed, automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited consumer-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

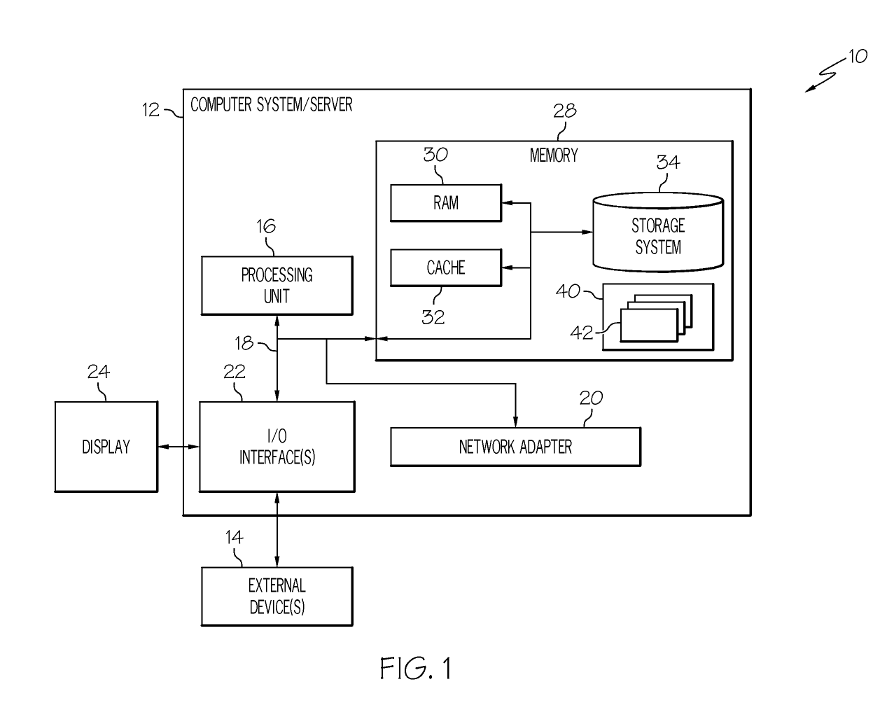

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

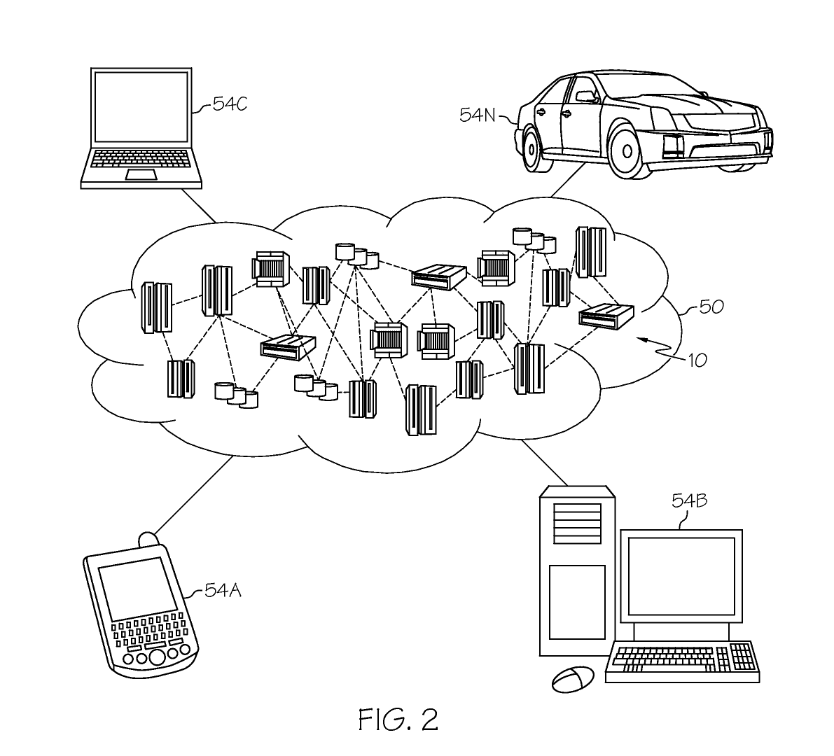

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as private, community, public, or hybrid clouds as described hereinabove, or a combination thereof. This allows cloud computing environment 50 to offer infrastructure, platforms, and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

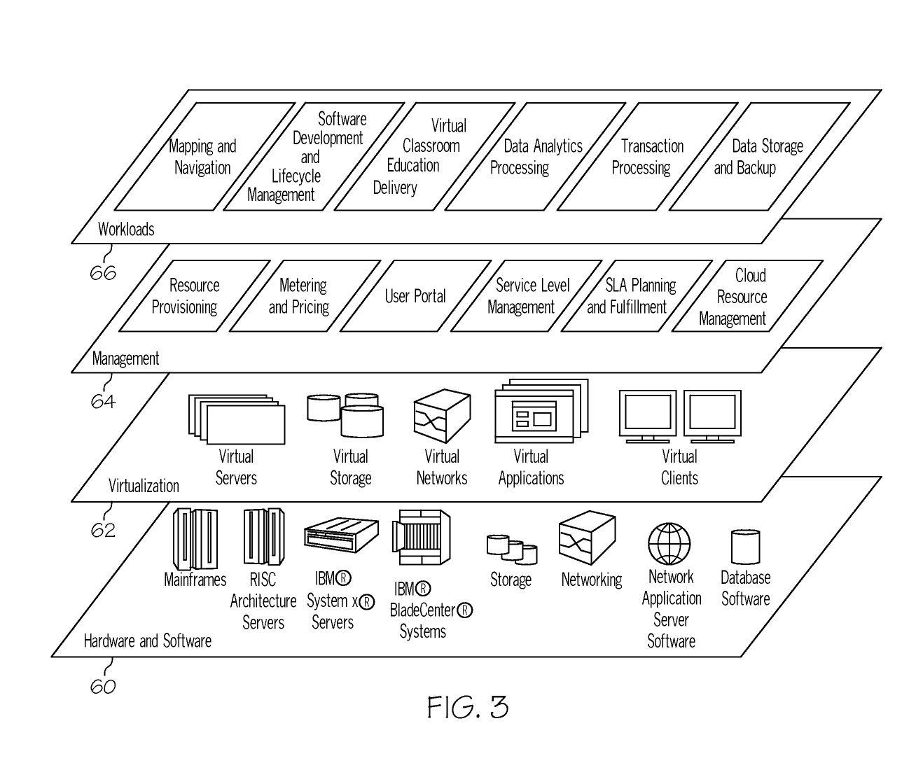

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes. Examples of software components include network application server software.

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. Consumer portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA. Further shown in management layer is cloud resource management, which represents the functionality that is provided under the embodiments of the present invention.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and data storage and backup. As mentioned above, all of the foregoing examples described with respect to FIG. 3 are illustrative only, and the invention is not limited to these examples.

It is understood that all functions of the present invention as described herein typically may be performed by the tenant SaaS service functionality (of management layer 64, which can be tangibly embodied as modules of program code 42 of program/utility 40 (FIG. 1). However, this need not be the case. Rather, the functionality recited herein could be carried out/implemented and/or enabled by any of the layers 60-66 shown in FIG. 3.

It is reiterated that although this disclosure includes a detailed description on cloud computing, implementation of the teachings recited herein are not limited to a cloud computing environment. Rather, the embodiments of the present invention are intended to be implemented with any type of networked computing environment now known or later developed.

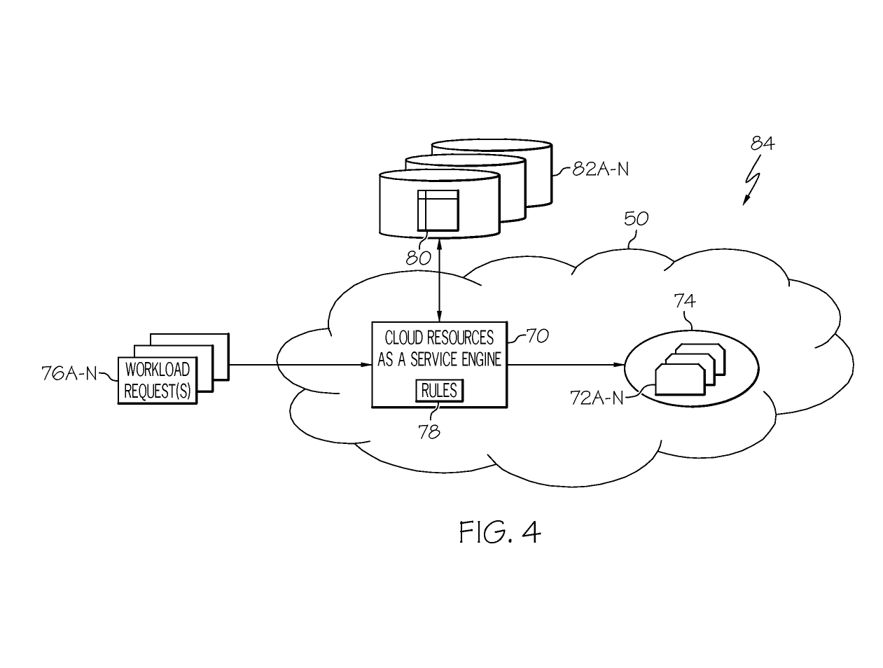

Referring now to FIG. 4, a system diagram describing the functionality discussed herein according to an embodiment of the present invention is shown. It is understood that the teachings recited herein may be practiced within any type of networked computing environment 84 (e.g., a cloud computing environment 50). A computer system/server 12, which can be implemented as either a stand-alone computer system or as a networked computer system is shown in FIG. 4. In the event the teachings recited herein are practiced in a networked computing environment 84, each client need not have a cloud resources as a service engine (engine 70). Rather, engine 70 could be loaded on a server or server-capable device that communicates (e.g., wirelessly) with the clients to provide cloud resources as a service management (e.g., application development, application provisioning, data storage, etc.) therefor. Regardless, as depicted, engine 70 is shown within computer system/server 12. In general, engine 70 can be implemented as program/utility 40 on computer system 12 of FIG. 1 and can enable the functions recited herein. As further shown, engine 70 (in one embodiment) comprises a rules and/or computational engine that processes a set (at least one) of rules/logic 72 and/or provides cloud resources as a service management hereunder.

Along these lines, engine 70 may perform multiple functions similar to a general-purpose computer. Specifically, among other functions, engine 70 may (among other things): connect to a tenant device among multiple tenant devices via a communication link; retrieve business data associated with a tenant from a storage area, wherein the tenant is associated with the tenant device; define application data, wherein the application data is associated with the business data; generate an interface template based on the application data; render a graphical user interface on the tenant device based on the interface template; edit the graphical user interface using the tenant device to create a desired graphical user interface; generate an application based on the desired graphical user interface; provide the application to at least one other tenant device among the multiple tenant devices; store the application data and business metadata at different storage areas; and/or dynamically generate a query based on the graphical user interface

### ILLUSTRATIVE EXAMPLE

It is understood that although this section describes software being offered as a service (e.g., SaaS), the embodiments described herein could be applied to any other type of cloud resource (e.g., IAAS, PAAS, etc.)

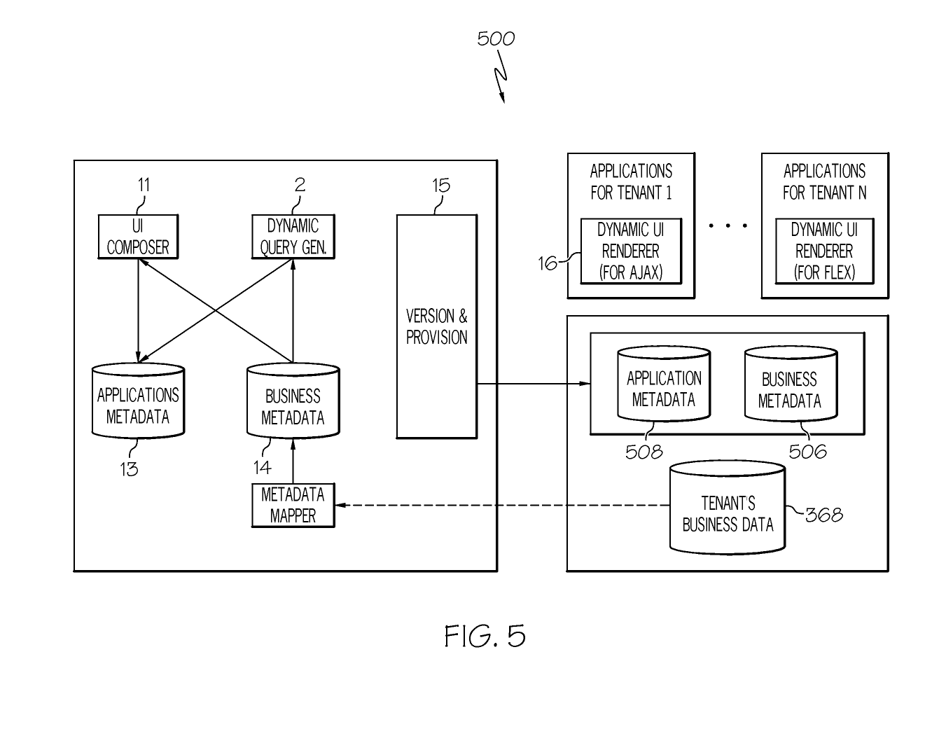

FIG. 5 illustrates an exemplary Software as a Service (SaaS) application development platform 500 that uses a graphical web user interface for developing, distributing, and performing an SaaS application, in accordance with one embodiment. The application development platform 500 resides in cloud computing environment 50 and comprises one or more cloud computing nodes 10. The application development platform 500 provides development, editing, and publishing tools designed to allow a user to design, create, edit, store, organize, and/or publish an SaaS application for multi-tenant. In the context of the present description, an SaaS application may include any service that relies on a database system or other data service that is accessible over a network.

In one example, the SaaS application may include a multi-tenant data service. In the present description, such multi-tenant SaaS application may include any service that relies on a database system or data service that is accessible over a network in which various elements of hardware and software of the database system may be shared by one or more tenants. A tenant refers to any one or more persons or entities that are capable of accessing the SaaS application in the present description. For example, the tenant(s) may subscribe to the SaaS application.

The SaaS application development platform 500 may include the following SaaS application management components: user interface (UI) composer 11, dynamic query generator 12, applications metadata 13, business metadata 14, version and provision component 15, and a metadata mapper. Other components within the SaaS application development platform 500 may include components associated with one or more tenants. For example, applications for Tenant 1 may include dynamic user interface (UI) renderer 16. Other components are shown in FIG. 5.

It is difficult to create a statically compiled application executable application that can meet these and other unique challenges of multi-tenancy. Inherently, a multi-tenant application must be dynamic in nature to fulfill the individual expectations of various tenants and their users.

The SaaS application development platform 500 provides an SaaS application composer (or UI composer) which is used to develop an application for a tenant in a multi-tenant environment. The UI composer 11 generates an interface template based on application data. The interface template may include a pattern, layout, and/or data view. The application data is associated with a tenant's metadata. The application data may comprise and/or be based upon the tenant metadata (e.g., via transformation). The dynamic UI renderer 16 is used to render a graphical user interface based on the application data. The UI composer 11 may be used to edit the graphical user interface to create a desired graphical user interface.

The dynamic query generator 12 may create a query and process a tenant's data service request based on the desired graphical user interface. An SaaS application may be created for the tenant based on the desired graphical user interface. The SaaS application may provide the SaaS application to at least one other tenant in a multi-tenant environment. In one example, the SaaS application may be provided to the other tenants via a provisioning process.

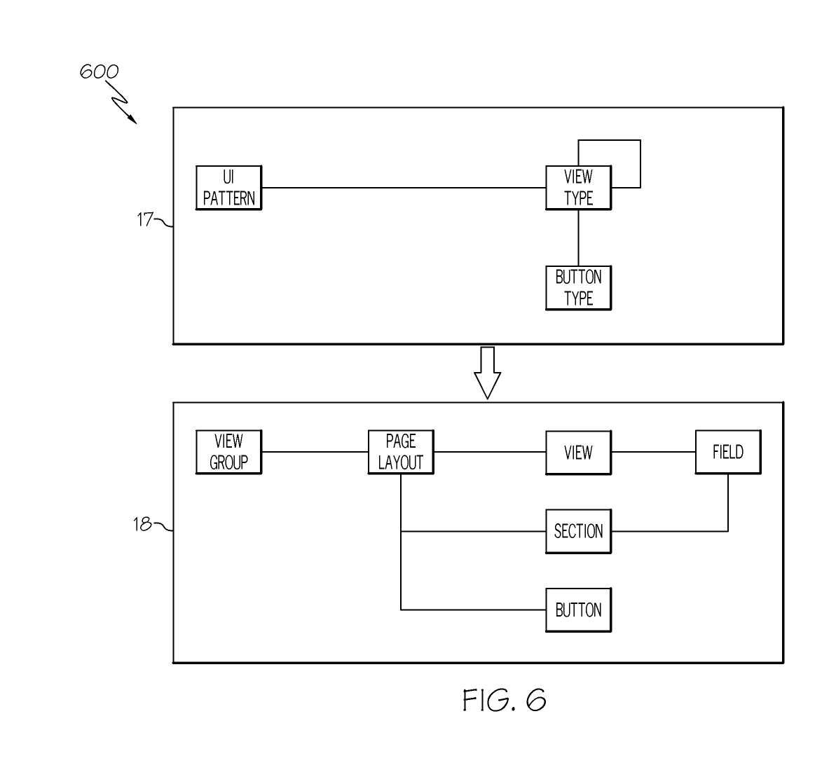

FIG. 6 depicts a pattern-based graphical user interface schematic 600 according to an embodiment of the present invention. The graphical user interface may be based on the respective tenant's data defined by a metadata structure associated with the tenant data. The metadata structure may include different types of the layouts, data views, and data transaction types.

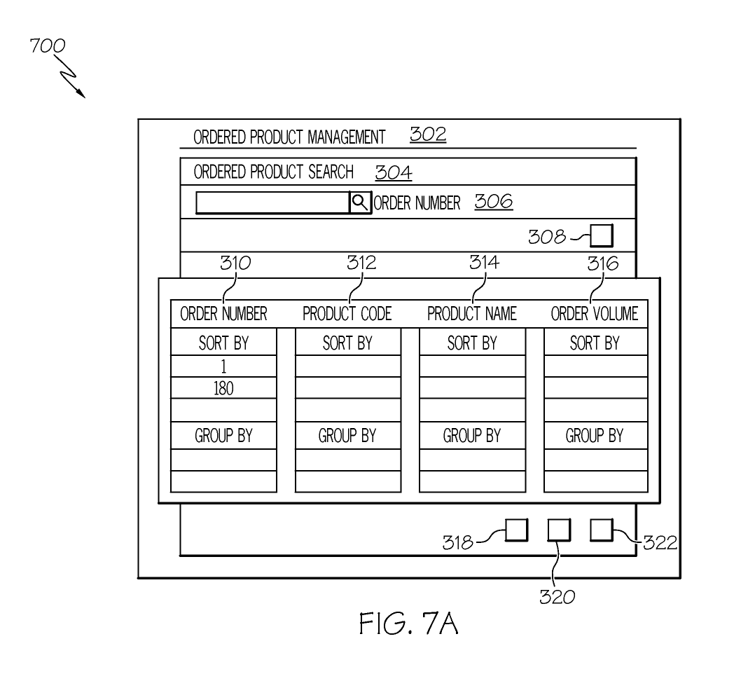

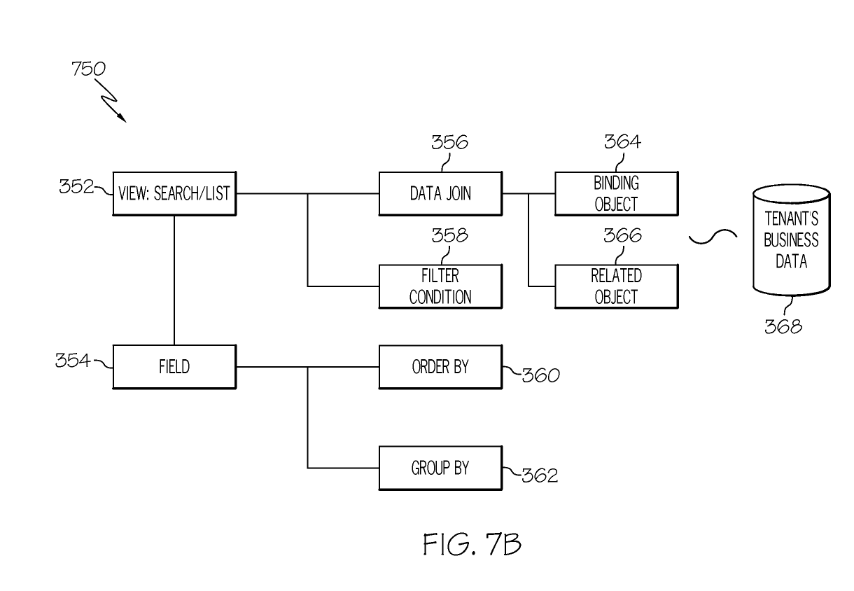

FIG. 7A depicts a data view screen shot 700 according to an embodiment of the present invention. The screen shot 700 depicts ordered product management' interface 302 associated with an example ordered product management database. The screen includes an ordered product search section 304 including order number search 306. A user may enter an order number and click the search/enter button 308. Data related to the searched order number (if found) may be returned and displayed on the screen. The screen further includes columns: order number 310, product code 312, product name 314, and order volume 316. Add 318, update 320, and delete 322 buttons may also be displayed on the screen for database maintenance.

FIG. 7B depicts a logical diagram 750 of a data view according to an embodiment of the present invention. The logical diagram 750 represents a schematic for the ordered product management data shown in FIG. 7A. The logical diagram 750 includes the following: view search/list 352, field 354, data join 356, filter condition 358, order by 360, group by 362, binding object 364, related object 366, and tenant's business data 368.

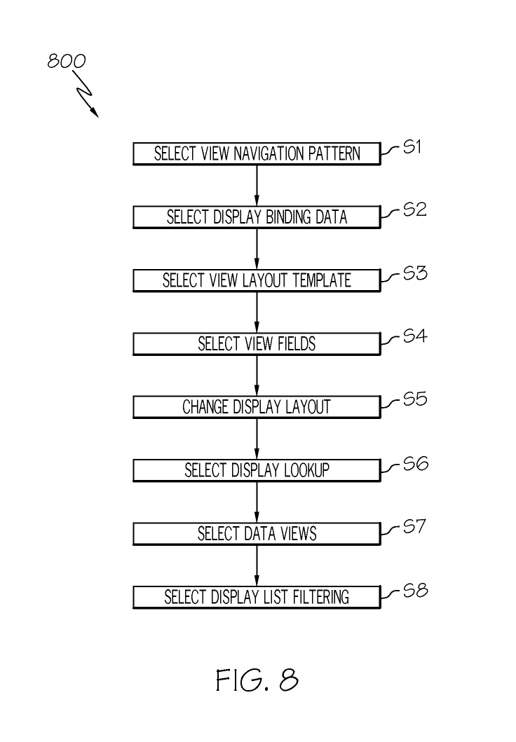

FIG. 8 depicts a graphical user interface method flow diagram 800 according to an embodiment of the present invention. At S1, a view navigation pattern is selected. At S2, a display binding data is selected. At S3, a view layout template is selected. At S4, one or more view fields are selected. At S5, a display layout is changed. At S6, optionally, a display lookup for referencing other data (e.g., master data, etc.) may be selected. At S7, one or more data views are selected. At S8, display list filtering is selected. In certain embodiments, the steps described above may be performed concurrently or in a different order than shown.

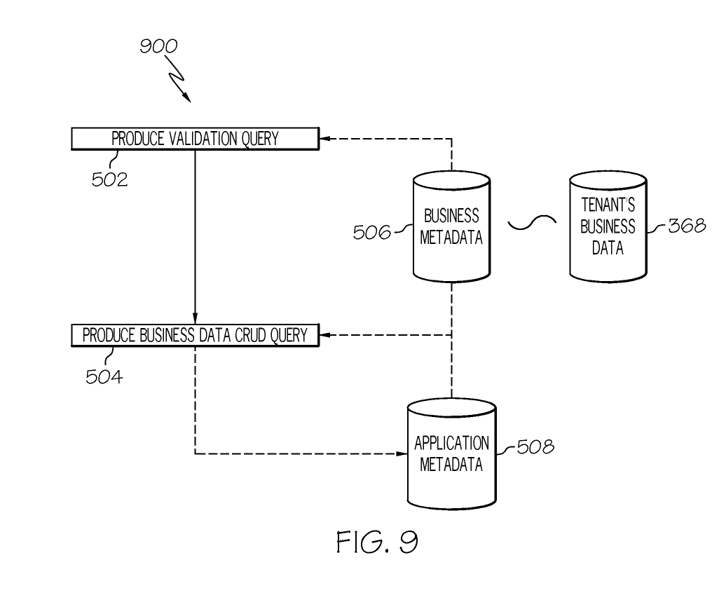

FIG. 9 depicts a schematic diagram 900 of an example query process according to an embodiment of the present invention. The query process includes producing a validation query based on the primary key/foreign key (PK/FK) constraints and uniqueness of the business metadata and input format validation 502. The validation query is produced using business metadata 506, application metadata 508 and tenant's business data 368. In one example, all or a portion of business metadata 506 may be associated with tenant's business data 368. Application metadata 508 may describe an application configuration and application data. Business metadata 506 and application metadata 508 may be used and produced by the processes and procedures of this invention. In the case of business metadata 506, the structure that represents the storage of the metadata may be separate from the structure that represents the storage of the tenant's business data 368. The validation query may validate relationships, unique constraints, and input values. A business data CRUD (create, read, update, and delete) query may be produced based on the business metadata and application metadata 504.

In one example, the query process may be performed in real time. For purposes of the present description, real time shall include any time frame of sufficiently short duration as to provide reasonable response time for information processing acceptable to a user of the subject matter described. Additionally, the term “real time” shall include what is commonly termed “near real time” which generally means any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

While shown and described herein as a multi-tenant SaaS data model solution in a cloud computing environment, it is understood that the invention further provides various alternative embodiments. For example, in one embodiment, the invention provides a computer-readable/useable medium that includes computer program code to enable a computer infrastructure to provide multi-tenant SaaS data model functionality in a cloud computing environment as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide multi-tenant SaaS data model functionality in a cloud computing environment. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for providing multi-tenant SaaS data model functionality in a cloud computing environment. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A system for providing a set of cloud resources in a cloud computing environment, comprising:
a memory medium comprising instructions;
a bus coupled to the memory medium; and
a processor coupled to the bus that when executing the instructions causes the system to:
connect to a tenant device among multiple tenant devices via a communication link;
retrieve business data associated with a tenant from a storage area, wherein the tenant is associated with the tenant device;
define application data, wherein the application data is associated with the business data;
generate an interface template based on the application data;
render a graphical user interface on the tenant device based on the interface template;
edit the graphical user interface using the tenant device to create a desired graphical user interface; and
generate an application based on the desired graphical user interface.

2. The server of claim 1, wherein the set of cloud resources comprises at least one of a Software as a Service (SaaS), Platform as a Service (PAAS), or Infrastructure as a Service (IaaS).

3. The server of claim 1, the memory medium further comprising instructions for causing the server to provide the application to at least one other tenant device among the multiple tenant devices.

4. The server of claim 1, wherein the application data comprises application metadata.

5. The server of claim 1, the memory medium further comprising instructions for causing the server to store the application data and business metadata at different storage areas.

6. The server of claim 1, the memory medium further comprising instructions for causing the server to dynamically generate a query based on the graphical user interface.

7. A computer-implemented method for providing a set of cloud resources as a service in a cloud computing environment, comprising:
connecting a server to a tenant device among multiple tenant devices via a communication link;
retrieving business data associated with a tenant from a storage area, wherein the tenant is associated with the tenant device;
defining application data, wherein the application data is associated with the business data;
generating an interface template based on the application data;
rendering a graphical user interface on the tenant device based on the interface template;
editing the graphical user interface using the tenant device to create a desired graphical user interface; and
generating an application based on the desired graphical user interface.

8. The computer-implemented method of claim 7, wherein the set of cloud resources comprises at least one of a Software as a Service (SaaS), Platform as a Service (PAAS), or Infrastructure as a Service (IaaS).

9. The computer-implemented method of claim 7, further comprising providing the application to at least one other tenant device among the multiple tenant devices.

10. The computer-implemented method of claim 7, wherein the application data comprises application metadata.

11. The computer-implemented method of claim 7, further comprising storing the application data and business metadata at different storage locations.

12. The computer-implemented method of claim 7, further comprising dynamically generating a query based on the graphical user interface.

13. A computer program product for managing Software as a Service (SaaS) resources in a networked computing environment, the computer program product comprising a computer readable storage media, and program instructions stored on the computer readable storage media, to:
connect to a tenant device among multiple tenant devices via a communication link;
retrieve business data associated with a tenant from a storage area, wherein the tenant is associated with the tenant device;
define application data, wherein the application data is associated with the business data;
generate an interface template based on the application data;
render a graphical user interface on the tenant device based on the interface template;
edit the graphical user interface using the tenant device to create a desired graphical user interface; and
generate an application based on the desired graphical user interface.

14. The computer program product of claim 13, wherein the set of cloud resources comprises at least one of a Software as a Service (SaaS), Platform as a Service (PAAS), or Infrastructure as a Service (IaaS).

15. The computer program product of claim 13, the computer readable storage media further comprising instructions to provide the application to at least one other tenant device among the multiple tenant devices.

16. The computer program product of claim 13, the computer readable storage media further comprising instructions to store the application data and business metadata at different storage locations.

17. The computer program product of claim 13, the computer readable storage media further comprising instructions to dynamically generate a query based on the graphical user interface.
